(19) United States
(12) Patent Application Publication
(10) Pub. No.: US 2017/0208742 A1
(43) Pub. Date: Jul. 27, 2017

(54) CROP TANK SYSTEM

(71) Applicant: CLAAS Selbstfahrende Erntemaschinen GmbH, Harsewinkel (DE)

(72) Inventors: Johann Ingibergsson, Copenhagen N.V. (DK); Kasper Lundberg Lykkegaard, København S (DK); Morten Rufus Blas, Kongens Lyngby (DK); Tommy Ertboelle Madsen, Fremont, CA (US)

(73) Assignee: CLAAS Selbstfahrende Erntemaschinen GmbH, Harsewinkel (DE)

(21) Appl. No.: 15/411,219

(22) Filed: Jan. 20, 2017

(30) Foreign Application Priority Data
Jan. 21, 2016 (DE) 102016100983.0

(51) Int. Cl. A01D 41/12; A01D 75/00; G01F 23/284; A01D 41/127

(52) U.S. Cl. CPC A01D 41/1208; A01D 41/127; A01D 41/1275; A01D 75/00; G01F 23/284

(57) ABSTRACT

A crop tank system has a crop tank for receiving harvested crop and a fill level sensor arrangement for detecting fill level information regarding the crop tank. The fill level sensor arrangement includes a radar sensor, which sends out and receives radar rays that, depending on the fill level of the crop contained in the crop tank, penetrate the crop contained in the crop tank and/or are reflected by the crop contained in the crop tank. The fill level sensor arrangement also includes an electronic sensor control, which determines the fill level information based on the received radar rays.

### CROSS REFERENCE TO RELATED APPLICATIONS

This application claims priority to German Patent Application No. DE 102016100983.0, filed Jan. 21, 2016, the entire disclosure of which is hereby incorporated herein by reference.

### TECHNICAL FIELD

A crop tank system is disclosed, together with an agricultural machine having a crop tank system and a method for conducting agricultural working processes.

Information about the performance of an agricultural machine such as a combine harvester is of particular importance for finding the optimized settings of its working organs. In this sense, information may be obtained about the fill level and/or the fill rate of the crop tank system, which is assigned to the agricultural machine. For this, the crop tank system disclosed is provided with a fill level sensor arrangement.

### BACKGROUND

The crop tank system disclosed in DE 103 45 612 A 1 includes a crop tank for receiving harvested crop and a fill level sensor arrangement for detecting fill level information of the crop tank. The fill level sensor arrangement includes a weighing sensor that determines the weight of the crop, which is contained in the crop tank. Although it is possible to achieve a high accuracy in the measurement, the constructional effort and the resulting costs are comparably high.

### SUMMARY

The present invention is directed to improving the known crop tank system such that the desired fill level information may be obtained with low constructional effort and low costs.

It has been found that radar sensors are generally suitable for determining fill level information of the crop tank. In one embodiment, the fill level arrangement includes a radar sensor, which sends out and receives radar rays. The proposed arrangement is such that the radar rays, depending on the fill level of the crop contained in the crop tank, penetrate the crop contained in the crop tank and/or are reflected by the crop contained in the crop tank. This means that the radar rays, which are being received by the radar sensor, allow the determination of the fill level information. For this determination of the fill level information based on the received radar rays, the fill level sensor arrangement includes an electronic sensor control, which may be part of a central control of the agricultural machine, such as a driver assistance system.

With the proposed crop tank system, fill level information may be obtained in a contact-free manner using a radar sensor, which may be realized with low costs.

The fill level information may include a number of aspects related to the fill level of the crop contained in the crop tank. Preferably, the fill level information includes the fill level as such and/or the filling rate of the crop tank.

It may be pointed out that the proposed solution is not restricted to the sensor arrangement having only one single sensor. It may well be advantageous to provide the fill level sensor arrangement with more than one sensor, in particular with more than one radar sensor. In this context it is also possible to provide the fill level sensor arrangement with a combination of one radar sensor or more radar sensors and at least another sensor of a different sensor principle.

There are various preferred locations of the radar sensor of the fill level sensor arrangement. In one embodiment, the radar sensor is located in the area of the top of the crop tank, such that the radar sensor operates from outside the crop. This is advantageous as the determination of the fill level may be obtained by the determination of the location of the surface of the crop contained in the crop tank. In another embodiment, however, the radar sensor operates from within the crop, which allows the radar sensor to be positioned such that it is no obstacle for other components of the agricultural machines such as a discharge trunk or the like.

Another aspect, which is of independent importance, is directed to an agricultural machine, in particular a combine harvester. The proposed agricultural machine is configured for conducting an agricultural working process and is provided with a driver assistance system and with a crop tank system as disclosed herein. The driver assistance system processes data such as the obtained fill level information for the running agricultural working process. As the proposed use of a radar sensor allows not only to obtain the fill level of the crop tank, but also other information such as crop moisture or the like, the data-processing of the obtained fill level information by the driver assistance system improves the agricultural working process altogether. For example, the driver assistance system data-processing of the obtained fill level information may be used for controlling at least one working organ of the agricultural machine based on the fill level information.

In addition or alternatively, it is proposed to store the obtained fill level information after a step of georeferencing in a local memory or a data base such that the fill level information may be relied on by subsequent agricultural working processes. This offline-approach may well be combined with the above noted online-approach in order to achieve best results in terms of efficiency. This aspect is particularly interesting for the fill rate being included in the fill level information.

Other aspects are directed to possible reactions of the driver assistance system on certain fill level information. For example, the adjustable chassis may be adjusted according to the obtained fill level information. This is advantageous in view of the fact that with increasing fill level the weight on the chassis of the agricultural machine increases. In order to prevent the increasing weight of the crop lowering the agricultural machine as such, it is proposed to have the adjustment of the chassis counteract the increasing weight of the crop. In a similar fashion, it is proposed in another to adjust the air pressure of the tires of the agricultural machine, depending on the fill level information, in particular depending on the obtained fill level of the crop tank.

In another aspect, which is of independent importance as well, a method is provided for conducting agricultural working processes with agricultural machines disclosed herein.

According to the proposed method, within a running agricultural working process, fill level information of the crop tank is obtained, wherein the obtained fill level information is data-processed for the running agricultural process and/or for subsequent working processes. The fill level information may be obtained within a running agricultural process, using the above noted, proposed radar sensor. Due to the above noted fact, that the radar sensor may obtain not only the fill level, but different other quantities, this approach may be the basis for the improvement of the running agricultural working process, and also for the improvement of parallel and/or subsequent agricultural working processes.

### BRIEF DESCRIPTION OF THE DRAWINGS

Further details, features, goals and advantages of the present invention shall be described in the following based on the illustration of a preferred embodiment. In the illustration, the figure shows the following:

FIG. 1 a schematic diagram of a proposed agricultural machine with a proposed crop tank system, each being suitable for conducting a harvesting process according to the proposed method; and

FIG. 2 a schematic diagram of another proposed agricultural machine with a proposed crop tank system, each being suitable for conducting a harvesting process according to the proposed method.

### DETAILED DESCRIPTION

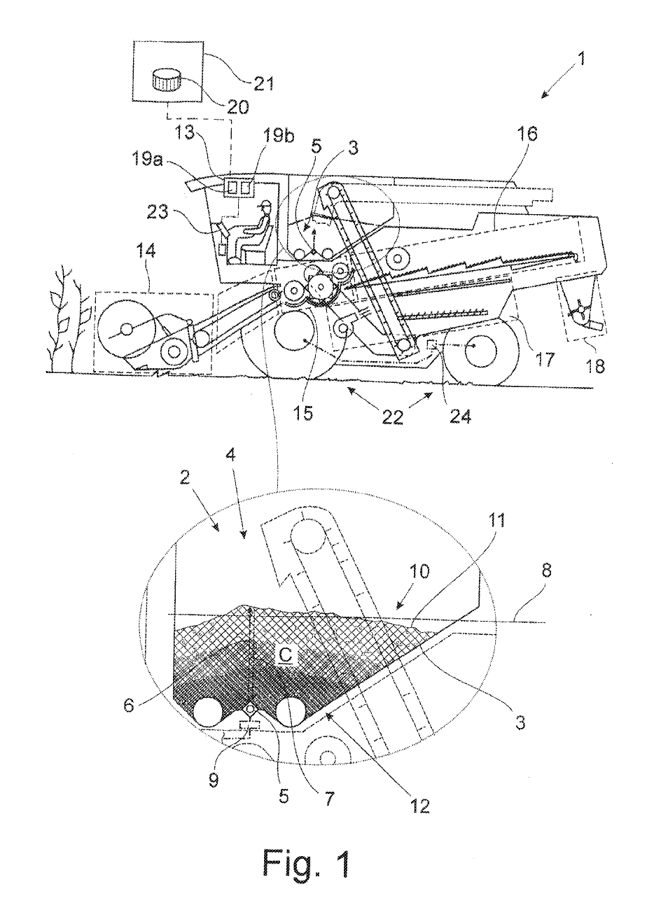

The agricultural machine 1 shown in FIG. 1 is designed as a combine as will be explained later. However, the proposed solution may be applied to any agricultural machine. For example, the agricultural machine may be a tractor, a trailer, or the like.

The drawings show two embodiments of a proposed agricultural machine 1, which is provided with a respective crop tank system 2. The crop tank system 2 comprises a crop tank 3 for receiving harvested crop C and a fill level sensor arrangement 4 for detecting fill level information regarding the crop tank 3. Preferably, the fill level information includes at least the fill level of the crop tank 3.

The fill level sensor arrangement 4 includes a radar sensor 5, which sends out and receives radar rays 6, 7 or beams. The working principle of such a radar sensor 5 is well known.

Depending on the fill level 8 of the crop C contained in the crop tank 3, the radar rays 6 penetrate the crop C contained in the crop tank 3 and/or are reflected by the crop C contained in the crop tank 3. The degree of penetration and reflection and damping of the radar rays 6, 7 depend on the crop, in particular the crop condition such as crop moisture.

The fill level sensor arrangement 4 includes an electronic sensor control 9 which determines the fill level information based on the received radar rays 7.

The fill level information can include various quantities that are directed to different aspects of the crop tank 3 with respect to the crop C contained in the crop tank 3. As noted above, preferably, the fill level information at least includes the fill level 8 of the crop tank 3. As an alternative, or in addition, the fill level information includes the fill rate of the crop tank 3. The fill rate, here and preferably, is the change of fill level per unit in time.

The fill level information may also include quantities regarding aspects of the crop tank 3, which are not directly connected to the fill level 8. Accordingly, the fill level information may include a crop condition such as crop moisture.

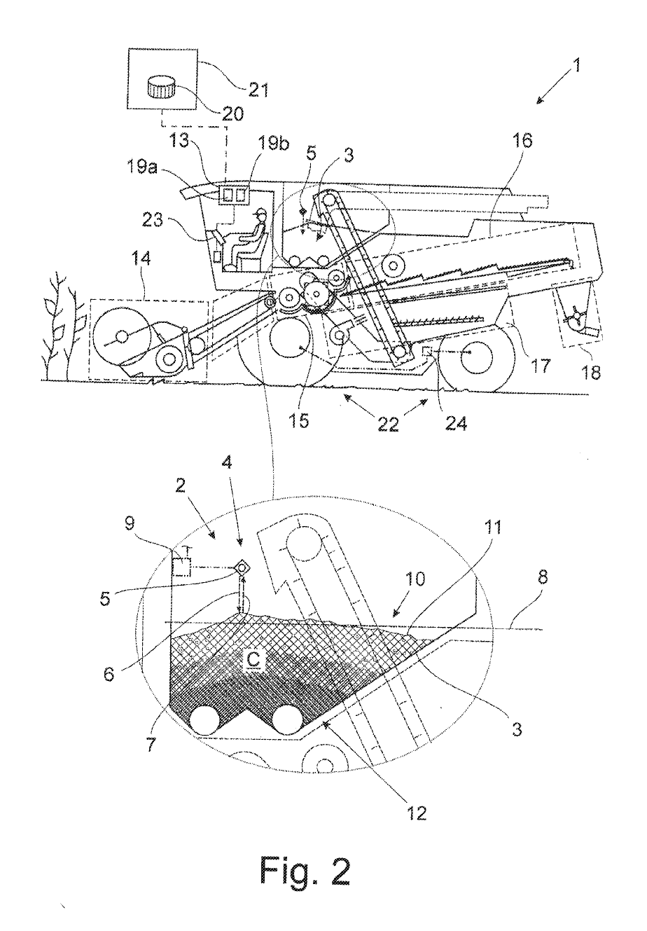

In the embodiment shown in FIG. 2, the radar sensor 5 is located in the area of the top 10 of the crop tank 3. Here and preferably, the radar sensor 5 shown in FIG. 2 is always free of the crop C contained in the crop tank 3. The radar sensor 5 is sending out radar rays 6 into the direction of the surface 11 of the crop C contained in the crop tank 3. The sensor control 9 preferably evaluates a value for the time needed for the radar ray 6, 7 to be reflected from the surface 11, which represents the distance between the radar sensor 5 and the point of reflection at the surface 11. This time may well be derived from a phase shift in the sent rays 6 versus the received rays 7.

In the embodiment as shown in FIG. 1, the radar sensor 5 is located in the area of the bottom 12 of the crop tank 3 and is sending out radar rays 6 in the direction of the surface 11 of the crop C contained in the crop tank 3. In this embodiment, the radar sensor 5 is located within the crop C contained in the crop tank 3. In both embodiments shown in the drawings, for determining the fill level information, the sensor control 9 locates the surface 11 of the crop C contained in the crop tank 3 based on the radar rays 7 received by the sensor 5.

The sensor control 9 evaluates a value for the time needed for the radar ray 6, 7 to be reflected, which represents the distance between the radar sensor 5 and the point of reflection as noted above. With the radar sensor 5 being located in the area of the bottom 12 of the crop tank 3, as shown in FIG. 1, the highest distance value may be a value for the fill level of the crop tank 3.

Alternatively or in addition, in the embodiment shown in FIG. 1, the sensor control 9 evaluates the portion of the sent radar rays 6, which is not being reflected back to the radar sensor 5. The idea behind this is the fact that depending on the fill level 8 of the crop C contained in the crop tank 3, a different portion of the sent radar rays 6 are completely passing through the crop C contained in the crop tank 3, and not being reflected to the radar sensor 5. Accordingly, based on the portion of the sent radar rays 6, which is not being reflected to the radar sensor 5, a value for the fill level of the crop tank 3 may be determined. Alternatively or in addition it may be foreseen that the sensor control 9 evaluates the damping of the received radar rays 7 with respect to the sent radar rays 6, in order to obtain the respective fill level information.

For the radar sensor 5, a measuring frequency between 0.1 GHz and 1 GHz has been proven to provide good and reproducible measurement results.

Depending on the measurement conditions, in particular depending on the crop conditions, the obtained fill level information may vary. This at least in some cases makes it necessary to run a calibration process before reliable fill level information is available. In the easiest case, during the calibration process, the crop tank 3 of the crop tank system 2 is filled manually to a 100% full level. After this has been done, the fill level sensor arrangement 4 runs a measurement, which measurement should show a fill level 8 of 100% full accordingly. If this is not the case, a correction value will be derived from the measured fill level and the actual fill level 8. All following measured fill levels will be corrected by this correction value.

In one embodiment, the agricultural machine 1, here and preferably, is a combine harvester. The agricultural machine 1 serves for conducting an agricultural working process and is provided with a driver assistance system 13 as well as with a proposed crop tank system 2. All explanations given regarding the proposed crop tank system 2 are fully applicable to agricultural machine embodiment.

The driver assistance system 13 processes the obtained fill level information for the running agricultural working process. It is also possible that the obtained fill level information will be used for parallel agricultural working processes and/or subsequent agricultural working processes, as will be explained later.

Preferably, the agricultural machine 1 is a self-propelled harvesting machine, in particular a combine as noted above. The agricultural machine 1 includes at least one working organ 14-18, wherein, here and preferably, the driver assistance system 13 serves for the control of at least one working organ 14-18. In the disclosed embodiments, the agricultural machine 1 includes a number of working organs 14-18, for example a front attachment 14, a threshing unit 15, a separating unit 16, a cleaning unit 17 and a distribution unit 18. Other working organs, not shown in the drawings, may include a traction drive, a steering drive, or the like.

Here and preferably, within the agricultural working process, the driver assistance system 13 processes the obtained fill level information by controlling at least one working organ 14-18 of the agricultural machine 1 based on the fill level information, which has been obtained in the running agricultural working process or a previous agricultural working process.

One example for this is the driver assistance system 13 following predefined operational strategies such as maximizing the crop output of the agricultural machine 1. Here, the driver assistance system 13 evaluates the obtained fill rate and controls the traction drive as well as the threshing unit 15 in order to comply with the operational strategy. Accordingly, the obtained fill level information is an integral part of a respective control loop of the agricultural machine 1.

Another example for processing the obtained fill level information may be the organization of tractor-pulled trailers, which serve to transport the harvested crop from the field. Here, the agricultural machine 1, depending on the fill level information, may send a request to an organizational network in order to have a trailer arrive at the field such that the crop C contained in the crop tank 3 may be transferred to the respective trailer.

The obtained fill level information may also be used for mapping of a field, which means that the obtained field information, preferably the fill rate, is stored in a data base 20 such that this information may be retrieved whenever an agricultural working process is to be conducted on this respective field. For this, here and preferably, the driver assistance system 13 processes the obtained fill level information by georeferencing the obtained fill level information. This means, that the driver assistance system 13 assigns each fill level information to the respective position information. Preferably, for obtaining the position information, the driver assistance system 13 comprises a positioning system, preferably a GPS-based positioning system. The georeferenced fill level information is stored in a memory 19a of the driver assistance system 13, which also is provided with a processing unit 19b to process the data contained in the memory 19a. The processing unit 19b may include a processor or other controller for controlling the agricultural machine or working process, including for example one or more working organs. The data stored on the memory 19a may include processor executable instructions that, when executed by the processor of the processing unit 19b, cause the processing unit 19b to implement the features described herein.

Alternatively or in addition, the georeferenced fill level information is being transmitted to a data base 20 by the driver assistance system 13. Here and preferably, the data base 20 is located on a data server 21, which is remote from the agricultural machine 1. The data server 21 may be a central server which administrates numerous data bases 20 representing the respective field information.

One advantage of storing the obtained fill level information in a data base 20 is the availability of the obtained fill level information for all subsequent agricultural working processes. Further it may be possible to establish a complete history of the obtained information such that trends in changes of the fill level information, in particular of the fill rate, may be detected. Those trends may trigger certain measures to counteract the detected trend.

Another possibility for the driver assistance system 13 to process the obtained fill level information relates to the agricultural machine 1 including an adjustable chassis 22 with wheels 25-28. In one embodiment, the driver assistance system 13, based on the obtained fill level information, adjusts the chassis 22 or proposes to the user such adjustment via a man-machine user interface 23. With this it is possible to prevent the agricultural machine 1 from lowering due to an increase of weight, which goes along with the increase of fill level 8.

In one embodiment, the agricultural machine 1 includes at least two above noted wheels with tires and an air pressure unit 24. The air pressure unit 24 may be controlled to change the air pressure of the tires assigned to the wheels. In one embodiment, the driver assistance system 13, based on the obtained fill level information, adjusts the air pressure of the tires or proposes to the user such adjustment via the above man-machine user interface 23. The adjustment of the air pressure of the tires may be done based on the above noted fill level information. By adjusting the air pressure of the tires it is generally possible to restrict the pressure exerted from the tires onto the ground, even if the weight of the agricultural machine 1 increases due to an increase in fill level 8.

According to another aspect, a method for conducting agricultural working processes with agricultural machines 1 as disclosed herein is provided.

In this aspect, a running agricultural working process includes obtaining fill level information regarding the crop tank 3, and that the obtained fill level information is processed for the running agricultural working process and/or for subsequent working processes.

The basic principle of using the obtained fill level information for conducting the agricultural working process is similar to the operation of the agricultural machine as described herein. However, it may be pointed out that according to the proposed method, the subsequent working processes may be conducted by any agricultural machine 1, which may or may not be designed according to the embodiments disclosed herein. Other than that, all explanations given for the operation of the agricultural machine 1 are fully applicable to the method for conducting the agricultural working processes.

An example for the proposed method is a combine conducting the harvesting process and at the same time obtaining the fill level information via the proposed fill level sensor arrangement 4. As noted with respect to the proposed agricultural machine 1, this fill level information is taken into account by the driver assistance system 13 for controlling the working organs 14-18. As, preferably, the obtained fill level information is being georeferenced and is either being stored in a local memory 19a or being transmitted to a data base 20. The fill level information may be used by subsequent agricultural working processes. As a result, the fill level information, which is obtained within the running agricultural process, is the basis for the operation of the agricultural machine 1 or another agricultural machine within in a subsequent agricultural working process. With the use of the fill level information not only for the running agricultural working process, but possibly also for a subsequent agricultural working process, a double use of the fill level information is resulting, which as such leads to an increase in efficiency.

### REFERENCE SIGN LIST

1 agricultural machine
2 crop tank system
3 crop tank
4 fill level sensor arrangement
5 radar sensor
6 sent radar rays
7 received radar rays
8 fill level
C crop
9 electronic sensor control
10 top area of crop tank
11 surface
12 bottom area of crop tank
13 driver assistance system
14-18 working organs
14 front attachment
15 threshing unit
16 separating unit
17 cleaning unit
18 distribution unit
19a memory
19b processing unit
20 data base
21 data server
22 chassis
23 man-machine-interface
24 air pressure unit

What is claimed is:

1. A crop tank system comprising:
a crop tank for receiving harvested crop; and
a fill level sensor arrangement configured to determine fill level information regarding the crop tank, wherein the fill level sensor arrangement comprises:
a radar sensor operable to send and receive radar rays, wherein the radar sensor is positioned to direct the radar rays toward the crop contained in the crop tank, wherein the radar rays are adapted to penetrate the crop contained in the crop tank and/or be reflected by the crop contained in the crop tank; and
an electronic sensor control operable to determine the fill level information based on the received radar rays.

2. The crop tank system according to claim 1, wherein the fill level information includes the fill level and/or the fill rate of the crop tank.

3. The crop tank system according to claim 2 wherein the fill level information further comprises crop moisture.

4. The crop tank system according to claim 1, wherein the radar sensor is positioned proximate the top of the crop tank to send radar rays in the direction of the surface of the crop contained in the crop tank.

5. The crop tank system according to claim 1, wherein the radar sensor is positioned proximate the bottom of the crop tank to send radar rays in the direction of the surface of the crop contained in the crop tank.

6. The crop tank system according to claim 1, wherein the sensor control determines the surface of the crop contained in the crop tank based on the received radar rays.

7. The crop tank system according to claim 1, wherein the sensor control evaluates the portion of the sent radar rays not being reflected to the radar sensor.

8. The crop tank system according to claim 1, wherein the sensor control evaluates the damping of the received radar rays with respect to the sent radar rays.

9. An agricultural machine for conducting a running agricultural working process comprising:
a driver assistance system; and
a crop tank system according to claim 1, wherein the driver assistance system is configured to process the obtained fill level information for the running agricultural working process and control the running agricultural working process in response to the obtained fill level information.

10. The agricultural machine according to claim 9, wherein the driver assistance system is operable to control at least one working organ of the agricultural machine based on the fill level information, which has been obtained in the running agricultural working process or a previous agricultural working process.

11. The agricultural machine according to claim 9, wherein the driver assistance system is configured to process the obtained fill level information by georeferencing the obtained fill level information and storing the georeferenced fill level information in a memory.

12. The agricultural machine according to claim 11 wherein the memory is a local memory.

13. The agricultural machine according to claim 11 wherein the memory comprises a database remote from the agricultural machine.

14. The agricultural machine according to claim 9, wherein the agricultural machine comprises an adjustable chassis with wheels, and wherein the driver assistance system, based on the obtained fill level information, is configured to adjust the chassis or propose an adjustment to the chassis to the user via a user interface .

15. The agricultural machine according to claim 14, wherein the agricultural machine comprises at least two wheels with tires and an air pressure unit controllable to change the air pressure of the tires, and wherein the driver assistance system, based on the obtained fill level information, is operable to control the air pressure unit to adjust the air pressure of the tires or propose to the user such adjustment via a user interface.

16. A method for conducting agricultural working processes with agricultural machines comprising:
running an agricultural working process with an agricultural machine comprising a crop tank;
depositing a harvested crop in the crop tank;
detecting a fill level of the crop tank by sending and receiving radar rays from a radar sensor directed toward the harvested crop in the crop tank and penetrating the harvested crop in the crop tank with the radar rays;
determining the fill level with an electronic sensor control based on the received radar rays; and
processing and storing fill level information for the running agricultural working process and/or for subsequent agricultural working processes.

17. The method according to claim 16, wherein the processing and storing of fill level information comprises georeferencing the fill level information and storing the georeferenced fill level information in a local memory or transmitting the georeferenced fill level information to a database remote from the agricultural machine.

18. The method according to claim 16 further comprising operating the agricultural machine based on the fill level information obtained within the running agricultural working process.

19. The method according to claim 16 further comprising operating another agricultural machine in a subsequent agricultural working process based on the fill level information obtained within the running agricultural working process.

20. The method according to claim 18 wherein the operating the agricultural machine comprises adjusting the air pressure of tires supporting the agricultural machine based on the fill level information.
